(19) United States
(12) Patent Application Publication
(10) Pub. No.: US 2026/0014641 A1
(43) Pub. Date: Jan. 15, 2026

(54) SONOTRODES FOR ULTRASONIC WELDING SYSTEMS, ULTRASONIC WELDING SYSTEMS, AND RELATED METHODS

(71) Applicant: Kulicke and Soffa Industries, Inc., Fort Washington, PA (US)

(72) Inventors: Henri Seppaenen, Irvine, CA (US); Tyler Ownby, Celina, TX (US)

(73) Assignee: Kulicke and Soffa Industries, Inc., Fort Washington, PA (US)

(21) Appl. No.: 19/264,128

(22) Filed: Jul. 9, 2025

Related U.S. Application Data
(60) Provisional application No. 63/669,740, filed on Jul. 11, 2024.

(51) Int. Cl. B23K 20/10

(52) U.S. Cl. CPC B23K 20/106

(57) ABSTRACT

A sonotrode configured for use in an ultrasonic welding system is provided. The sonotrode includes a body portion terminating at a tip portion, the tip portion includes (i) an alignment feature and (ii) a working surface configured to press against a base portion of a conductive pin during an ultrasonic welding process. The working surface defines an aperture configured to receive an elongate portion of the conductive pin. The alignment feature is configured to align the conductive pin with respect to the aperture.

### CROSS-REFERENCE TO RELATED APPLICATION

This application claims the benefit of U.S. Provisional Application No. 63/669,740 filed on Jul. 11, 2024, the content of which is incorporated herein by reference.

### FIELD

The invention relates to ultrasonic welding, and more particularly, to improved sonotrodes for use in ultrasonic welding systems, such as ultrasonic welding systems for conductive pin welding.

### BACKGROUND

Ultrasonic welding is a technology used for joining conductive components. Ultrasonic welding may use an ultrasonic converter (e.g., carrying a sonotrode) for converting electrical energy into mechanical movement/scrub (e.g., linear movement/scrub, torsional movement/scrub, etc.). U.S. Pat. No. 10,882,134 and U.S. Pat. No. 11,364,565 (each entitled “ULTRASONIC WELDING SYSTEMS AND METHODS OF USING THE SAME”), assigned to Kulicke and Soffa Industries, Inc., relate to improvements in ultrasonic welding technology, and are incorporated by reference in their entirety.

A specific application of ultrasonic welding technology relates to ultrasonic pin welding (where such pins are conventionally solder and/or press fit into power modules). U.S. Pat. No. 11,850,676 (entitled “ULTRASONIC WELDING SYSTEMS, METHODS OF USING THE SAME, AND RELATED WORKPIECES INCLUDING WELDED CONDUCTIVE PINS”), U.S. Pat. No. 12,070,814 (entitled “ULTRASONIC WELDING SYSTEMS, METHODS OF USING THE SAME, AND RELATED WORKPIECES INCLUDING WELDED CONDUCTIVE PINS”), U.S. Patent Application Publication No. 2024/0359255 (entitled “ULTRASONIC WELDING SYSTEMS, METHODS OF USING THE SAME, AND RELATED WORKPIECES INCLUDING WELDED CONDUCTIVE PINS”), U.S. Patent Application Publication No. 2024/0351132 (entitled “ULTRASONIC WELDING SYSTEMS FOR CONDUCTIVE PINS, AND RELATED METHODS”), International Patent Publication No. WO2024/0220203 (entitled “ULTRASONIC WELDING SYSTEMS, SONOTRODES AND CONDUCTIVE PINS FOR SUCH SYSTEMS, AND RELATED METHODS AND WORKPIECES”), and U.S. Patent Application Publication No. 2025/0187103 (entitled “CONDUCTIVE PINS, POWER MODULES, ULTRASONIC WELDING SYSTEMS, AND METHODS OF USING THE SAME”), each assigned to Kulicke and Soffa Industries, Inc., relate to improvements in ultrasonic welding technology related to conductive pins, and are also incorporated by reference in their entirety.

In practice, a sonotrode may be used to pick up a conductive pin prior to ultrasonic welding of the conductive pin to a workpiece. During pick up and/or ultrasonic welding, a conductive pin may be misaligned with respect to the sonotrode. Further, in ultrasonic pin welding, unwelded material of conductive pins may form undesired “whiskers” (e.g., long strands of unwelded material), where such whiskers may result in short circuiting in a workpiece.

Thus, it would be desirable to provide improved sonotrodes, and ultrasonic welding systems including such sonotrodes, configured for use in connection with ultrasonic pin welding.

### SUMMARY

According to an exemplary embodiment of the invention, a sonotrode configured for use in an ultrasonic welding system is provided. The sonotrode includes a body portion terminating at a tip portion, the tip portion including (i) an alignment feature and (ii) a working surface configured to press against a base portion of a conductive pin during an ultrasonic welding process. The working surface defines an aperture configured to receive an elongate portion of the conductive pin, the alignment feature being configured to align the conductive pin with respect to the aperture.

According to another exemplary embodiment of the invention, an ultrasonic welding system is provided. The ultrasonic welding system includes a support structure configured for supporting a workpiece and a weld head assembly. The weld head assembly includes an ultrasonic converter carrying a sonotrode configured for use in the ultrasonic welding system, the sonotrode including a body portion terminating at a tip portion. The tip portion includes an alignment feature and a working surface configured to press against a base portion of a conductive pin during an ultrasonic welding process, the working surface defining an aperture configured to receive an elongate portion of the conductive pin, the alignment feature being configured to align the conductive pin with respect to the aperture.

According to other embodiments of the invention, the sonotrode and/or the ultrasonic welding system recited in the two immediately preceding paragraphs may have any one or more of the following features: the alignment feature is a tapered surface of the tip portion extending toward the working surface; the alignment feature includes a plurality of tapered portions extending toward the working surface; depressions are defined between the plurality of tapered portions; the plurality of tapered portions extend above a planar surface of the tip portion; the planar surface is continuous with the working surface; the tip portion defines an outer portion between the alignment feature and an outer edge of the tip portion, the outer portion including (i) a plurality of outer protrusions and (ii) depressions between ones of the plurality of outer protrusions; ones of the plurality of tapered portions are integrated with ones of the plurality of outer protrusions; the plurality of tapered portions and the plurality of outer protrusions extend above a planar surface of the tip portion; the planar surface is continuous with the working surface; the alignment feature is a curved surface of the tip portion extending toward the working surface; the alignment feature includes a plurality of curved portions extending toward the working surface; depressions are defined between the plurality of curved portions; a plurality of protrusions extend from a planar portion of the working surface; the plurality of protrusions are arranged radially between the aperture and the alignment feature; ones of the plurality of protrusions are offset from adjacent ones of the plurality of protrusions; a plurality of grooves are defined by a planar portion of the working surface; the plurality of grooves are arranged radially between the aperture and the alignment feature; ones of the plurality of grooves are offset from adjacent ones of the plurality of grooves; the alignment feature is configured to contact the base portion of the conductive pin when the conductive pin is picked up by the sonotrode, and then the alignment feature aligns the conductive pin with respect to the aperture, and then the working surface contacts the base portion of the conductive pin during the ultrasonic welding process; the conductive pin is picked up by the sonotrode using a vacuum source, and wherein the vacuum source assists in aligning of the conductive pin with respect to the aperture; the alignment feature is configured to center the conductive pin with respect to the aperture during alignment; the tip portion defines an outer portion between the alignment feature and an edge of the tip portion, the outer portion including (i) a plurality of outer protrusions and (ii) depressions between ones of the plurality of outer protrusions; the plurality of outer protrusions extend above a planar surface of the tip portion; and the planar surface is continuous with the working surface.

According to another exemplary embodiment of the invention, a method of operating an ultrasonic welding system is provided. The method includes the steps of (a) providing a conductive pin to a sonotrode of the ultrasonic welding system, the sonotrode including a body portion terminating at a tip portion, the tip portion including (i) an alignment feature and (ii) a working surface configured to press against a base portion of the conductive pin during an ultrasonic welding process; and (b) aligning the conductive pin with respect to an aperture defined by the sonotrode using the alignment feature.

According to other embodiments of the invention, the method of operating an ultrasonic welding system recited in the immediately preceding paragraph may have any one or more of the following features: step (a) includes picking up the conductive pin using the sonotrode; the sonotrode picks up the conductive pin using a vacuum source; step (b) includes using a vacuum source coupled to the sonotrode, wherein the vacuum source assists in the aligning of the conductive pin with respect to the aperture; the alignment feature is a tapered surface of the tip portion extending toward the working surface; depressions are defined between the plurality of tapered portions; the plurality of tapered portions extend above a planar surface of the tip portion; the planar surface is continuous with the working surface; the tip portion defines an outer portion between the alignment feature and an outer edge of the tip portion, the outer portion including (i) a plurality of outer protrusions and (ii) depressions between ones of the plurality of outer protrusions; ones of the plurality of tapered portions are integrated with ones of the plurality of outer protrusions; the plurality of tapered portions and the plurality of outer protrusions extend above a planar surface of the tip portion; the planar surface is continuous with the working surface; the alignment feature is a curved surface of the tip portion extending toward the working surface; the alignment feature includes a plurality of curved portions extending toward the working surface; depressions are defined between the plurality of curved portions; a plurality of protrusions extend from a planar portion of the working surface; the plurality of protrusions are arranged radially between the aperture of the sonotrode and the alignment feature, the aperture being configured to receive an elongate portion of the conductive pin; a plurality of grooves are defined by a planar portion of the working surface; the plurality of grooves are arranged radially between the aperture of the sonotrode and the alignment feature, the aperture being configured to receive an elongate portion of the conductive pin; ones of the plurality of grooves are offset from adjacent ones of the plurality of grooves; the alignment feature is configured to contact the base portion of the conductive pin during step (a); the alignment feature is configured to center the conductive pin with respect to the aperture of the sonotrode during step (b), wherein the aperture is configured to receive an elongate portion of the conductive pin; further comprising step (c) ultrasonically welding the conductive pin to a workpiece after step (b); step (c) includes contacting the base portion of the conductive pin with the working surface during the ultrasonic welding; step (c) includes using torsional welding for ultrasonically welding the conductive pin to the workpiece; the tip portion defines an outer portion between the alignment feature and an edge of the tip portion, the outer portion including (i) a plurality of outer protrusions and (ii) depressions between ones of the plurality of outer protrusions; the plurality of outer protrusions extend above a planar surface of the tip portion; and the planar surface is continuous with the working surface.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a block diagram side view of an ultrasonic welding system in accordance with an exemplary embodiment of the invention;

FIGS. 2A-2F are block diagram side views illustrating a process of operating an ultrasonic welding system in accordance with an exemplary embodiment of the invention; and

FIGS. 3A-3C, 4A-4C, 5A-5C, 6A-6C, 7A-7C, 8A-8C, 9A-9C, 10A-10C, 11A-11C, 12A-12C, 13A-13C, 14A-14C, 15A-15C, 16A-16D, 17A-17D, 18A-18D, and 19A-19D are various views of tip portions of sonotrodes in accordance with various exemplary embodiments of the invention.

### DETAILED DESCRIPTION

According to exemplary embodiments of the invention, alignment features (e.g., conductive pin alignment features) are provided in a tip portion of a sonotrode. Such alignment features may be used to align a conductive pin in the center of the sonotrode while pin welding (e.g., torsional ultrasonic pin welding) is performed. Exemplary alignment features have an angled shape and a radial symmetry with the sonotrode center line.

An alignment feature may be designed to fit an exemplary conductive pin diameter. Alignment features within the scope of the invention may include structured shapes or patterns. Such structured shapes or patterns may help to deform a conductive pin while seated in the sonotrode. Such structured shapes or patterns may also increase friction and contact force between (i) a tip portion of the sonotrode and (ii) the conductive pin, which helps engagement between the conductive pin and the sonotrode, and helps welding during an ultrasonic welding process. Alignment features within the scope of the invention may provide easier alignment for standard flat head conductive pins.

As used herein, the term “conductive pin” is intended to refer to any conductive structure intended to be welded to a workpiece. The conductive pin may have a free end (after being welded to a workpiece), and a body portion of the conductive pin may extend substantially vertically from a “welded” end to the free end. The cross section of the conductive pin may be round, square, rectangular, or have any desired cross section. The term conductive pin shall also be construed to include conductive receptacles or sleeves (e.g., having a tubular shape such as a rivet), where the conductive receptacle/sleeve is ultrasonically welded to a workpiece, and configured to receive another conductive element.

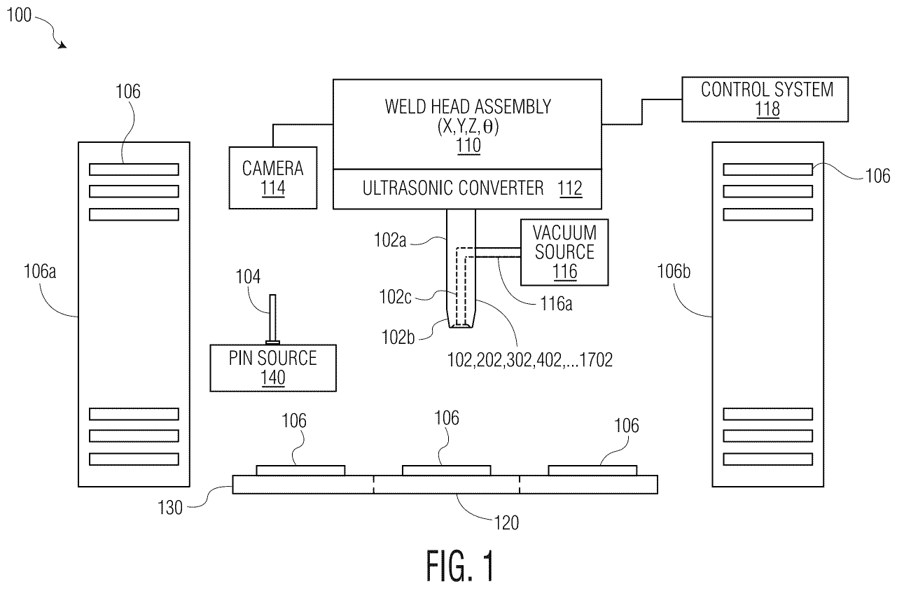

Referring now to FIG. 1, an ultrasonic welding system 100 is illustrated. Ultrasonic welding system 100 includes a weld head assembly 110, a control system 118, an input workpiece supply 106a, an output workpiece supply 106b, a support structure 120, a material handling system 130, and a pin source 140.

Weld head assembly 110 is configured to translate along an x-direction, y-direction, and z-direction, and to rotate in a θ-direction (e.g., wherein the θ direction is a rotation about the z-direction axis of weld head assembly 110). Weld head assembly 110 includes an ultrasonic converter 112 for generating ultrasonic motion during a welding operation (e.g., wherein the ultrasonic motion is torsional motion, wherein the ultrasonic motion is linear motion, etc.). Ultrasonic converter 112 is configured to receive a sonotrode 102, which performs the welding operation. Weld head assembly 110 includes a camera 114, for example, for locating a bonding location on a workpiece 106. Control system 118 is configured to control the motion of weld head assembly 110 (e.g., motion along the x-, y-, z-, and θ-directions), and/or to control ultrasonic converter 112 during welding operations.

Sonotrode 102 is configured to ultrasonically weld a conductive pin 104 to workpiece 106 during a welding operation. Sonotrode 102 could be any of the sonotrodes described herein (i.e., sonotrode 102, sonotrode 202, sonotrode 302, sonotrode 402, sonotrode 502, sonotrode 602, sonotrode 702, sonotrode 802, sonotrode 902, sonotrode 1002, sonotrode 1102, sonotrode 1202, sonotrode 1302, sonotrode 1402, sonotrode 1502, sonotrode 1602, or sonotrode 1702), or any other sonotrode falling within the scope of the invention (e.g., any combination of the sonotrode features described herein, any other sonotrodes described herein but not pictured, etc.). Sonotrode 102 includes a body portion 102a terminating at a tip portion 102b. Sonotrode 102 defines an aperture 102c configured to receive conductive pin 104. Sonotrode 102 may be configured to pick up conductive pin 104 via a vacuum source 116, though the invention is not so limited (e.g., sonotrode 102 may pick up conductive pin 104 via a gripper, electromagnetics, or any other conventional apparatus). Vacuum source 116 is connected to aperture 102c of sonotrode 102 via vacuum piping 116a. Tip portion 102b of sonotrode 102 includes a working surface 102b2 and an alignment feature 102b1, both of which will be described in greater detail herein.

Input workpiece supply 106a is configured to supply workpieces 106 to material handling system 130 prior to welding operations (e.g., from a workpiece magazine). Material handling system 130 provides workpieces to support structure 120, which supports workpieces 106 during welding operations. Material handling system 130 then moves processed workpieces 106 from support structure 120 to output workpiece supply 106b, which stores processed workpieces 106 (e.g., in an output workpiece magazine).

Pin source 140 provides conductive pins 104 for use by sonotrode 102 in connection with welding operations. Transfer of conductive pins 104 between pin source 140 and sonotrode 102 can be accomplished by any known process (e.g., vacuum transfer, etc.).

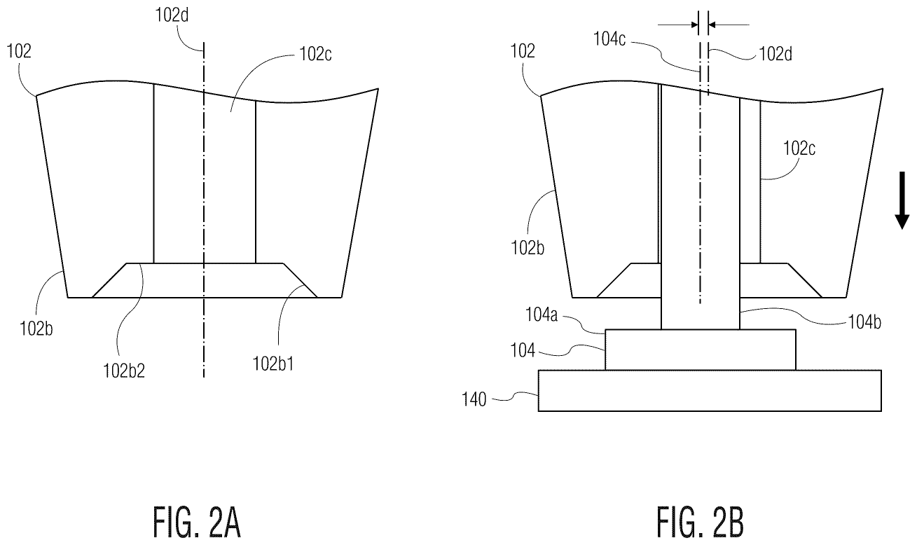

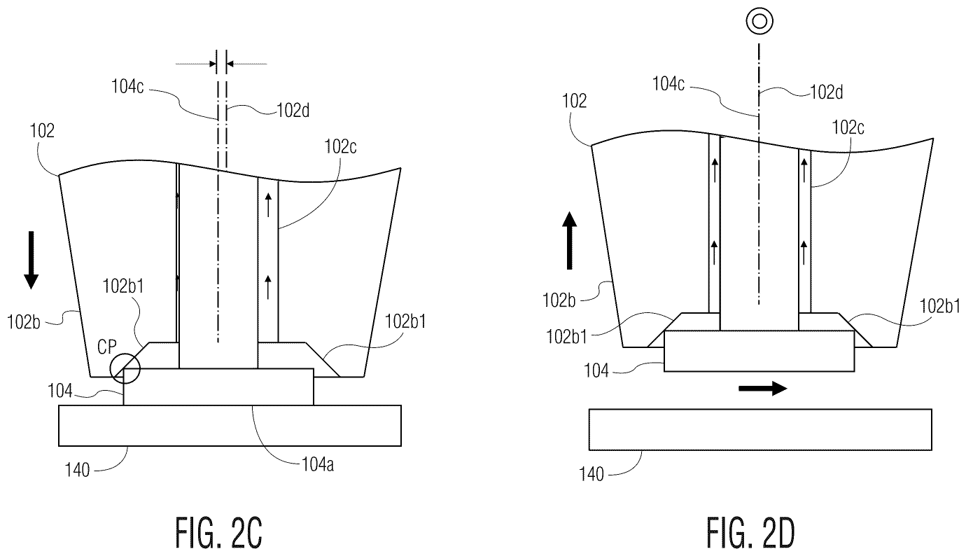

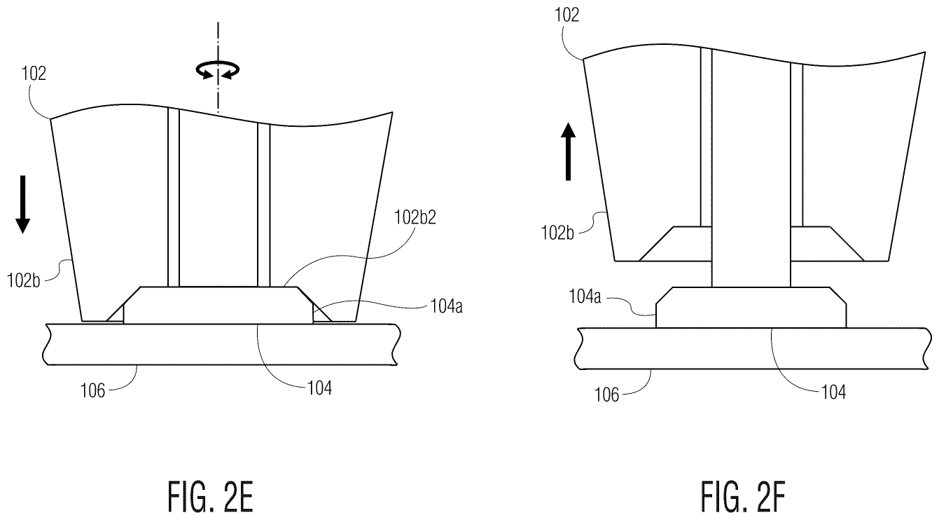

FIGS. 2A-2F illustrate tip portion 102b of sonotrode 102. Illustrated in FIG. 2A, sonotrode 102 includes aperture 102c, a working surface 102b2, and an alignment feature 102b1. A sonotrode centerline 102d is also illustrated. Aperture 102c is configured to receive an elongate portion 104b of conductive pin 104. In FIG. 2B, sonotrode 102 is descending to pick up conductive pin 104 from pin source 140. Conductive pin 104 includes a base portion 104a and elongate portion 104b. A conductive pin centerline 104c is offset from sonotrode centerline 102d (i.e., conductive pin 104 is not centered within sonotrode 102).

In FIG. 2C, sonotrode 102 has been lowered to engage conductive pin 104, and a vacuum is being drawn through aperture 102c (indicated by arrows in aperture 102c, wherein the vacuum is provided by, for example, vacuum source 116) to secure conductive pin 104 in sonotrode 102. As sonotrode 102 is lowered, an edge of base portion 104a is contacting one side of alignment feature 102b1, indicated by the circled portion CP. In FIG. 2D, sonotrode 102 has moved away from pin source 140 with a vacuum continuing to be drawn through aperture 102c. Alignment feature 102b1 has aligned conductive pin 104 with respect to aperture 102c, thus sonotrode centerline 102d and conductive pin centerline 104c are coincident. In the illustrated embodiment, the vacuum drawn through aperture 102c has pulled base portion 104a along alignment feature 102b1 until base portion 104a was properly aligned, in this case, centered within sonotrode 102.

FIG. 2E illustrates sonotrode 102 ultrasonically welding conductive pin 104 to workpiece 106. Sonotrode 102 is pressing against base portion 104a with working surface 102b2 and vibrating ultrasonically (e.g., using torsional motion). In FIG. 2F, conductive pin 104 has been ultrasonically welded to workpiece 106, and sonotrode 102 is moving away from workpiece 106. In this example, the edge of base portion 104a (i.e., an upper edge which was in contact with alignment feature 102b1) has been deformed during welding.

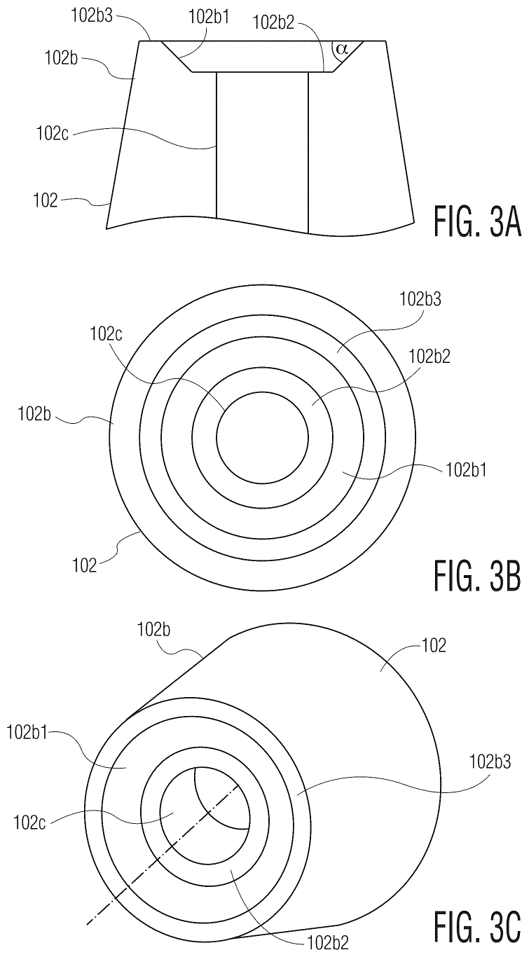

FIGS. 3A-3C illustrate tip portion 102b in additional detail. FIG. 3A illustrates a cross sectional side view of tip portion 102b. Alignment feature 102b1 is a tapered surface (e.g., a chamfer) extending toward working surface 102b2. Alignment feature 102b1 is illustrated as having an angle (“α”) of approximately 45°0 from working surface 102b2. Exemplary ranges for the angle are: 20°-70°; 30°-60°; and 40°-50°. Both alignment feature 102b1 and working surface 102b2 are smooth surfaces. FIG. 3B is a bottom view of tip portion 102b detailing the overall shape of tip portion 102b. FIG. 3C is a perspective view of tip portion 102b further detailing the shape and texture of alignment feature 102b1 and working surface 102b2.

Although FIGS. 1, 2A-2F, and 3A-3C illustrate tip portion 102b as having a particular geometry, the invention is not limited to such embodiments. Additional embodiments of the tip portion of the sonotrode are illustrated and described herein (e.g., various types of alignment features). Further, other exemplary features may improve engagement between the sonotrode and the conductive pin during welding or may otherwise provide improvements to the welding process such that less defects occur during welding.

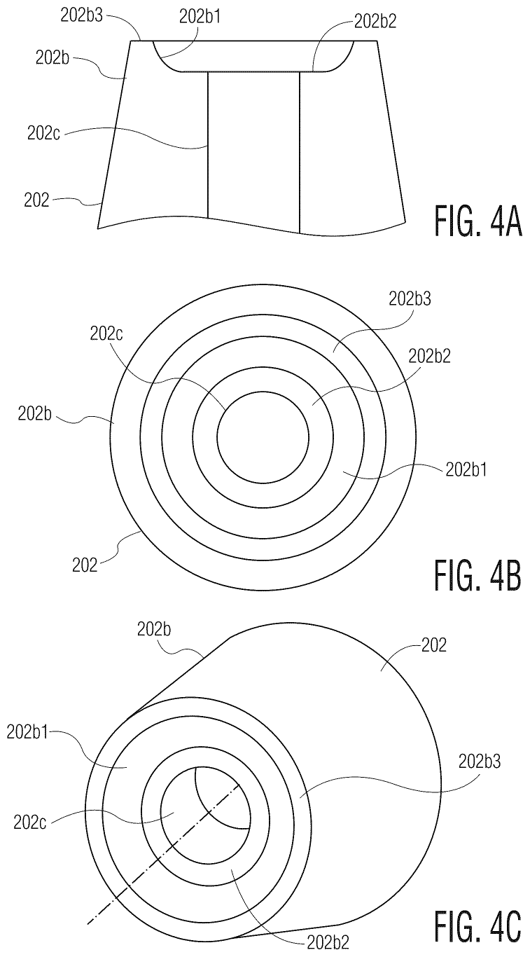

FIGS. 4A-4C illustrate a tip portion 202b of a sonotrode 202, which defines an aperture 202c. An alignment feature 202b1 has a concavely curved surface. In the illustrated embodiment in FIGS. 4A-4C (and in the other exemplary sonotrodes illustrated herein), a working surface 202b2 is planar but is not limited thereto. It is contemplated that an alignment feature could include a convexly curved surface, or a curved surface with convex and concave surfaces, all within the scope of the invention.

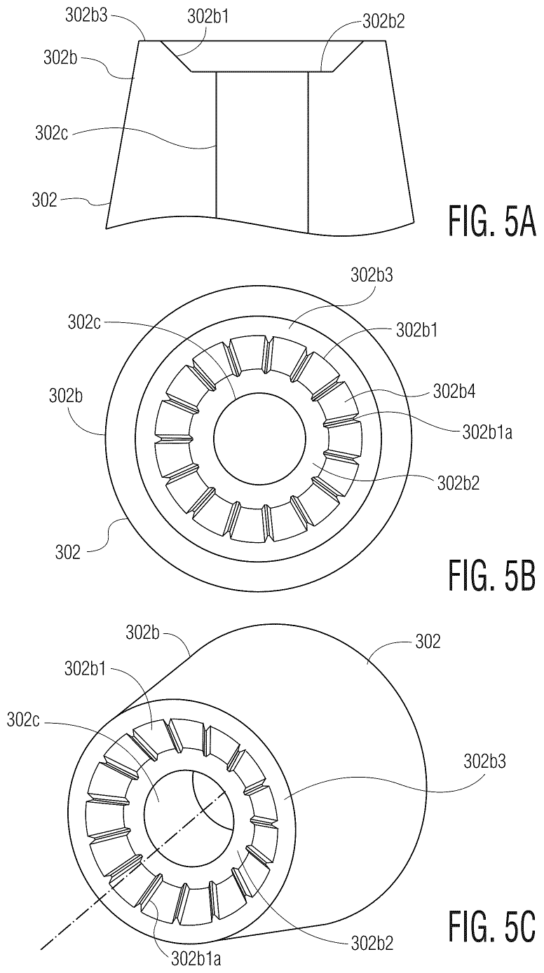

The following embodiments illustrate and describe tip portions with an alignment feature including an angled surface rather than a curved surface for purposes of brevity. However, any embodiment described herein may include either an angled surface, a curved surface, or a combination of an angled surface and a curved surface, all within the scope of the invention. Further, each of FIGS. 5A, 6A, 7A, 8A, 9A, 10A, 11A, 12A, 13A, 14A, and 15A illustrate a simplified sectional view and may not match the actual configuration of the alignment feature-where the actual configuration is shown in the corresponding end and perspective end views (e.g., see FIGS. 5B-5C, FIGS. 6B-6C, FIGS. 7B-7C, FIGS. 8B-8C, FIGS. 9B-9C, FIGS. 10B-10C, FIGS. 11B-11C, FIGS. 12B-12C, FIGS. 13B-13C, FIGS. 14B-14C, FIGS. 15B-15C).

FIGS. 5A-5C illustrate a tip portion 302b of a sonotrode 302, which defines an aperture 302c and a working surface 302b2 (e.g., a planar working surface). An alignment feature 302b1 includes a plurality of protrusions 302b1a (e.g., tapered portions) arranged in a radial configuration/pattern around aperture 302c. A plurality of depressions 302b4 are defined between the plurality of protrusions 302b1a. It should be understood that depressions 302b4 are defined by a relative dimensional difference (e.g., a height difference) from the adjacent protrusions 302b1a. The tip portion 302b illustrated in FIGS. 5A-5C may be described as an embodiment where alignment feature 302b1 includes a plurality of tapered portions (i.e., fifteen regions of alignment feature 302b1) extending toward working surface 302b2.

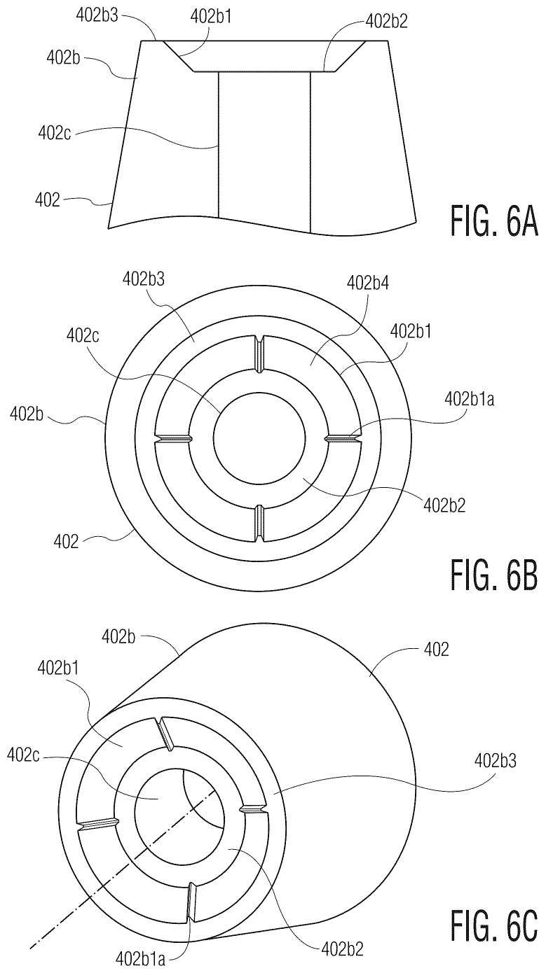

FIGS. 6A-6C illustrate a tip portion 402b of a sonotrode 402, which defines an aperture 402c and a working surface 402b2. An alignment feature 402b1 of sonotrode 402 includes a plurality of protrusions 402b1a that are similar to protrusions 302b1a (though fewer in number) as well as a plurality of depressions 402b4. It is contemplated that an alignment feature may include any number of protrusions (e.g., 5, 10, etc.), the protrusions having any shape, profile, or width, all within the scope of the invention. It is also contemplated that there could be multiple rows of protrusions. The tip portion 402b illustrated in FIGS. 6A-6C may be described as an embodiment where alignment feature 402b1 includes a plurality of tapered portions (i.e., four regions of alignment feature 402b1) extending toward working surface 402b2.

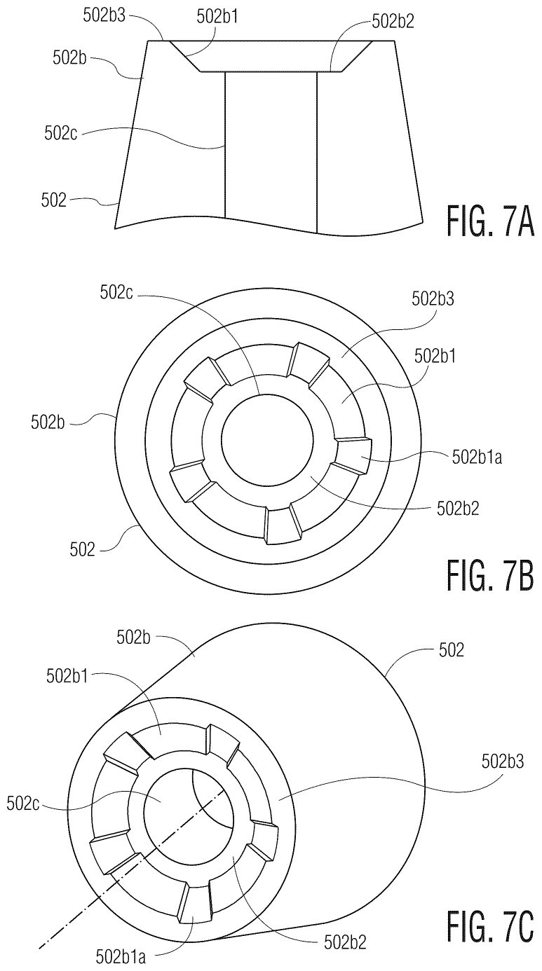

FIGS. 7A-7C illustrate a tip portion 502b of a sonotrode 502, which defines an aperture 502c and a working surface 502b2. An alignment feature 502b1 of sonotrode 502 includes a plurality of depressions 502b1a. Although the embodiment is illustrated with five depressions, the invention is not so limited, as it is contemplated that a sonotrode could have any number of depressions with any shape, width, or profile. It is also contemplated that there could be multiple rows of depressions. The tip portion 502b illustrated in FIGS. 7A-7C may be described as an embodiment where alignment feature 502b1 includes a plurality of tapered portions (i.e., five regions of alignment feature 502b1) extending toward working surface 502b2. In the illustrated embodiment, the plurality of depressions 502b1a are defined between the plurality of tapered portions.

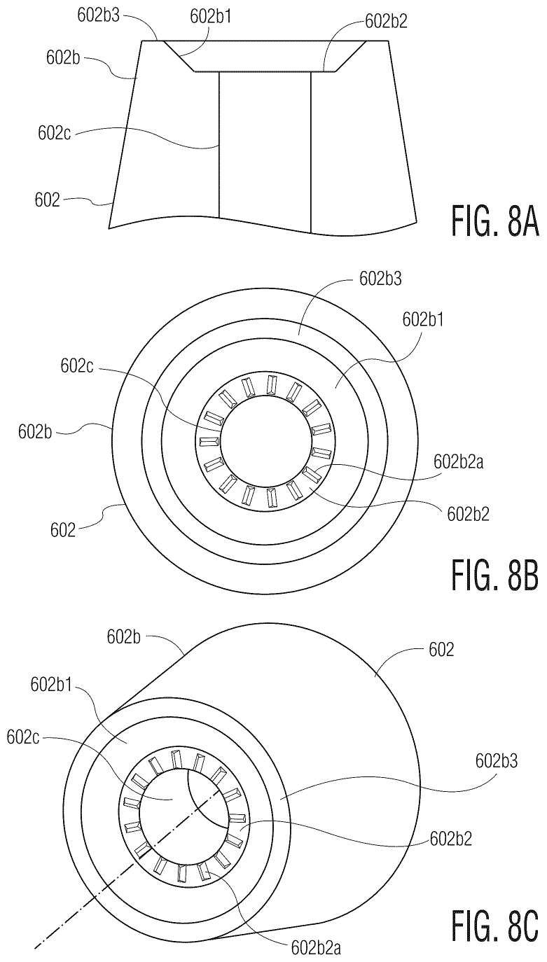

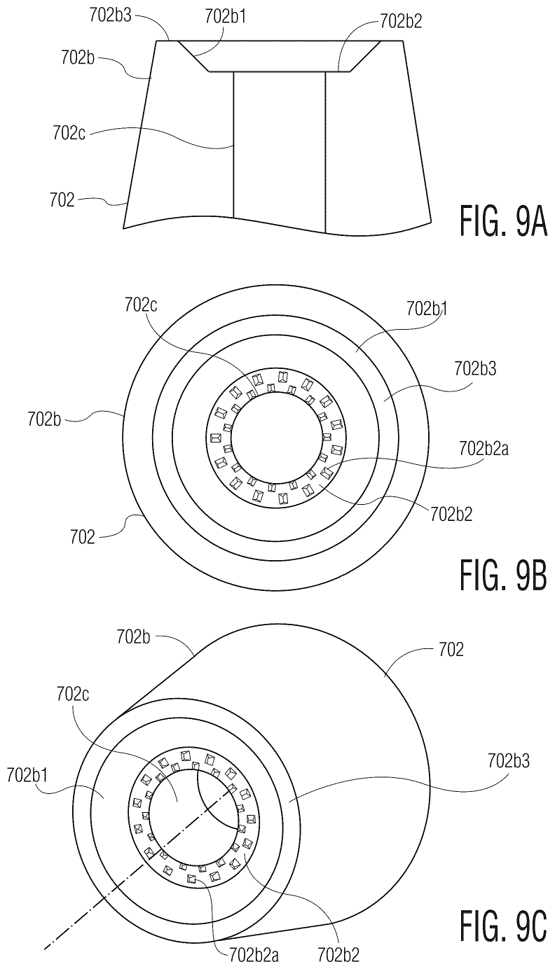

FIGS. 8A-8C illustrate a tip portion 602b of a sonotrode 602. A working surface 602b2 of sonotrode 602 includes a plurality of protrusions 602b2a extending from a planar portion of working surface 602b2 in a radial pattern between an alignment feature 602b1 and an aperture 602c. The plurality of protrusions 602b2a are arranged radially between aperture 602c and alignment feature 602b1. Protrusions may occur in any number, profile, shape, width, etc. It is also contemplated that there could be multiple rows of protrusions. For example, FIGS. 9A-9C illustrate a tip portion 702b of a sonotrode 702, defining an aperture 702c. Working surface 702b2 includes a plurality of protrusions 702b2a occurring in multiple rows (e.g., multiple concentric rows). It is contemplated that additional rows could be useful, or that each row could have a different shape of protrusions, all within the scope of the invention. In the exemplary embodiment shown in FIGS. 9A-9C, ones of the plurality of protrusions are offset from adjacent ones of the plurality of protrusions (e.g., protrusions in the inner row are offset from protrusions in the adjacent outer row).

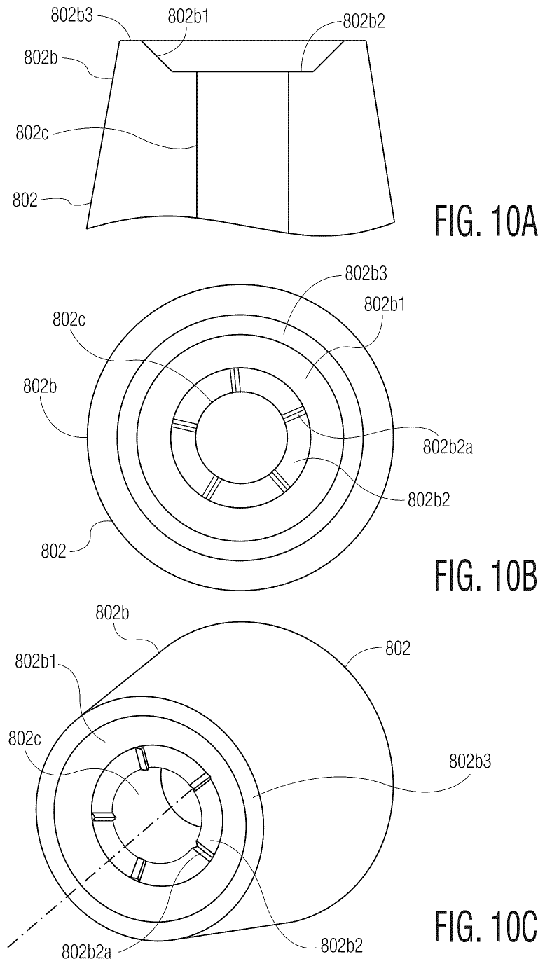

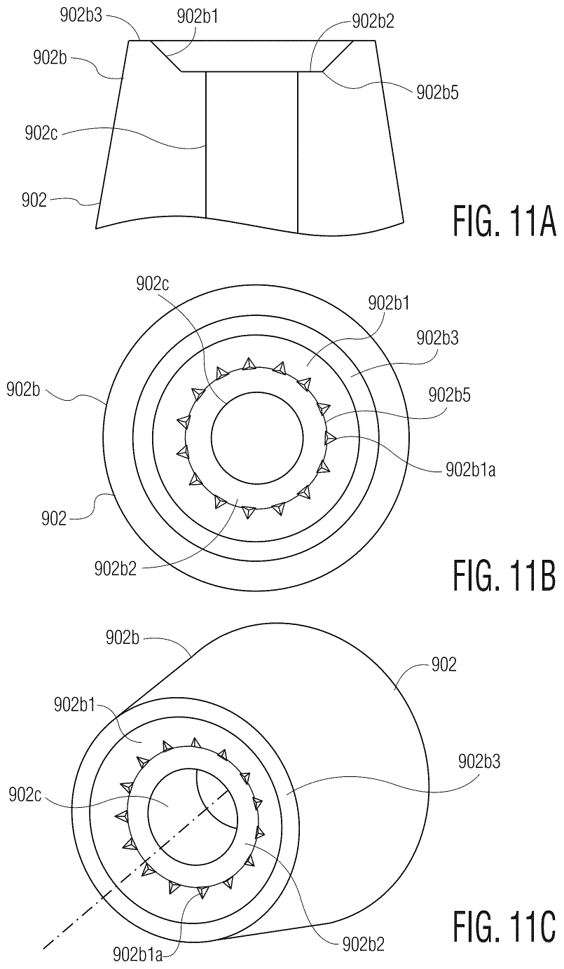

FIGS. 10A-10C illustrate a tip portion 802b of a sonotrode 802, defining an aperture 802c, and including a working surface 802b2 and an alignment feature 802b1. A plurality of grooves 802b2a are defined by a planar portion of working surface 802b2. The plurality of grooves 802b2a may occur in any number, profile, shape, width, etc. It is also contemplated that there could be multiple rows of grooves. In the illustrated embodiment, the plurality of grooves 802b2a are arranged radially between aperture 802c and alignment feature 802b1. In certain embodiments, ones of the plurality of grooves 802b2a may be offset from adjacent ones of the plurality of grooves 802b2a.

FIGS. 11A-11C illustrate a tip portion 902b of a sonotrode 902, defining an aperture 902c. A plurality of protrusions 902b1a are provided at an interface 902b5 between an alignment feature 902b1 and a working surface 902b2. Protrusions may occur in any number, profile, shape, width, etc.

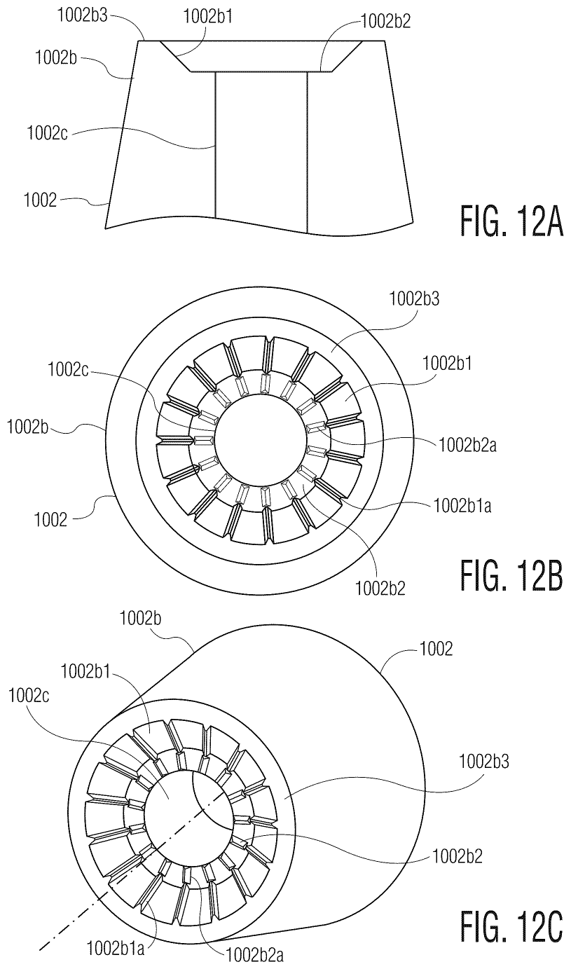

In addition to embodiments that include a single surface having an additional feature (e.g., the protrusions, grooves, and/or depressions illustrated in FIGS. 5-11), it is contemplated that any of the features illustrated and/or described herein can be combined with any other feature illustrated and/or described herein. For example, FIGS. 12A-12C illustrate a tip portion 1002b of a sonotrode 1002, defining an aperture 1002c. Protrusions 1002b1a extend from an alignment feature 1002b1 and protrusions 1002b2a extend from a working surface 1002b2. It is contemplated that there could be any number of protrusions, a different number of protrusions on each surface, the protrusions of one surface can be offset from protrusions of the other surface, etc. The tip portion 1002b illustrated in FIGS. 12A-12C may be described as an embodiment where alignment feature 1002b1 includes a plurality of tapered portions (i.e., fifteen regions of alignment feature 1002b1) extending toward working surface 1002b2.

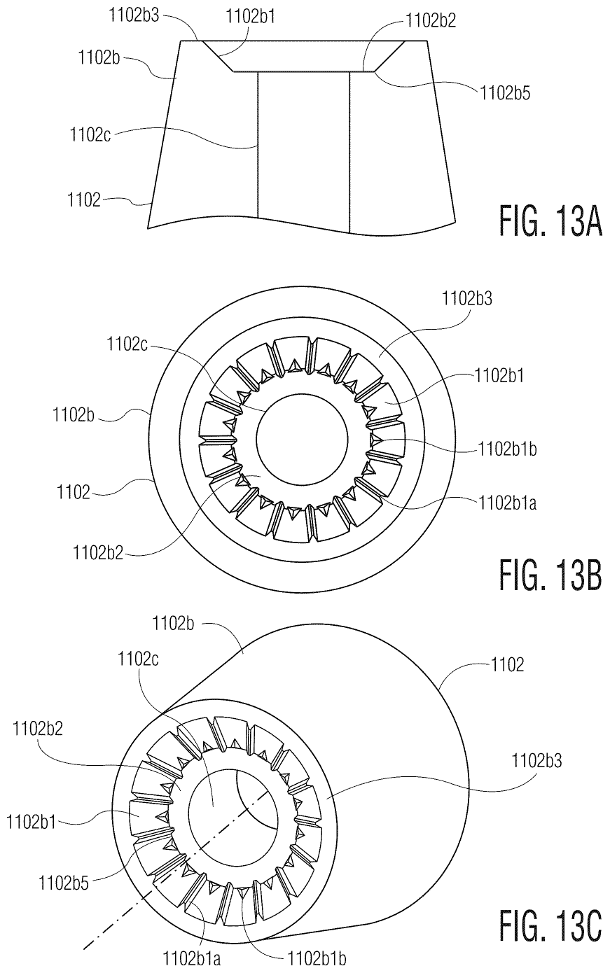

FIGS. 13A-13C illustrate a tip portion 1102b of a sonotrode 1102, defining an aperture 1102c. A plurality of protrusions 1102b1a extend from an alignment feature 1102b1, and a plurality of protrusions 1102b1b are provided at an interface 1102b5 between alignment feature 1102b1 and a working surface 1102b2. It is contemplated that there could be any number of protrusions, a different number of protrusions on each surface, one plurality of protrusions can be offset from the other plurality of protrusions, etc. The tip portion 1102b illustrated in FIGS. 13A-13C may be described as an embodiment where alignment feature 1102b1 includes a plurality of tapered portions (i.e., fifteen regions of alignment feature 1102b1) extending toward working surface 1102b2.

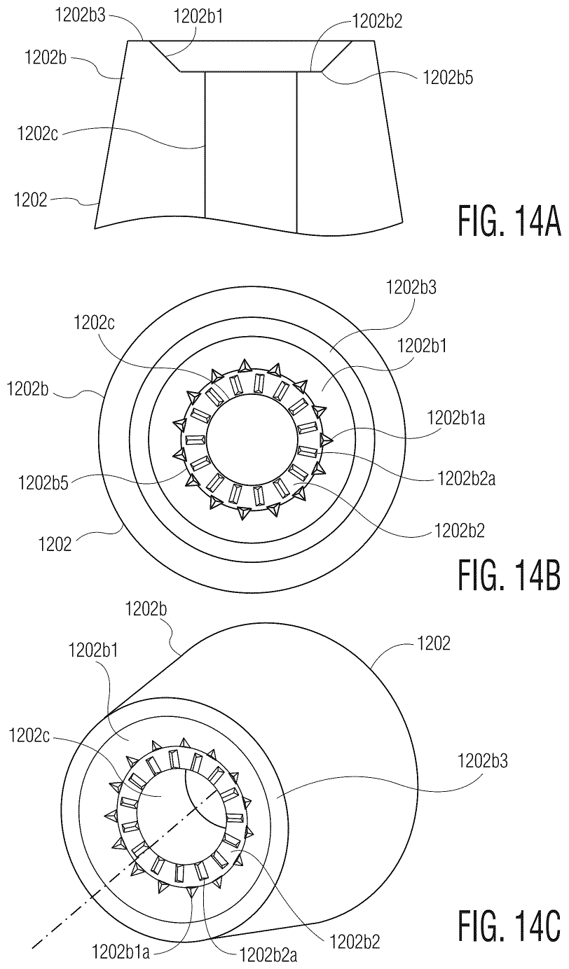

FIGS. 14A-14C illustrate a tip portion 1202b of a sonotrode 1202, defining an aperture 1202c. A plurality of protrusions 1202b1a are provided at an interface 1202b5 between an alignment feature 1202b1 and a working surface 1202b2 and another plurality of protrusions 1202b2a extending from working surface 1202b2.

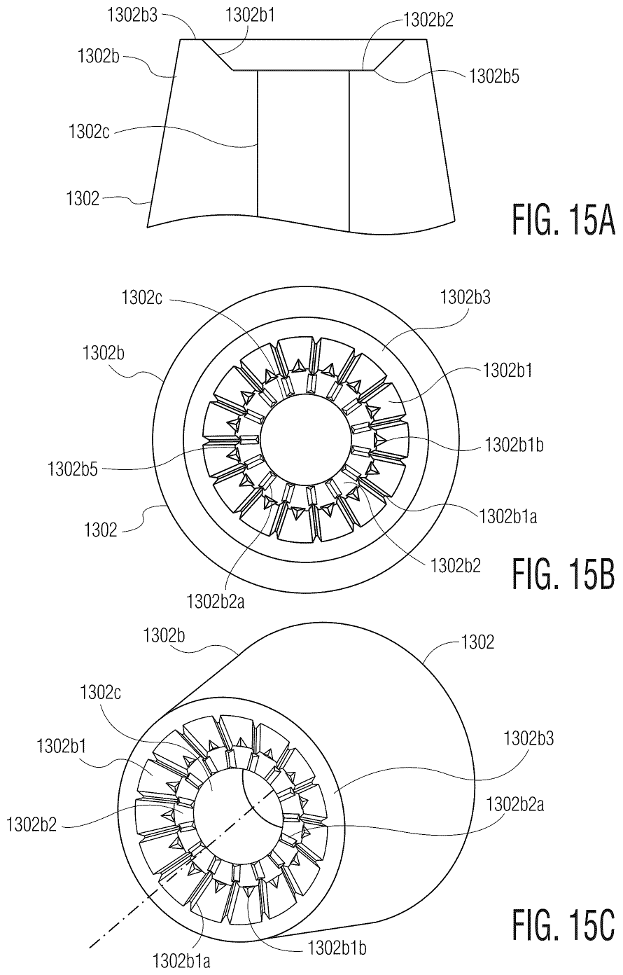

FIGS. 15A-15C illustrate a tip portion 1302b of a sonotrode 1302, defining an aperture 1302c. A plurality of protrusions 1302b1a extend from an alignment feature 1302b1, another plurality of protrusions 1302b1b are provided at an interface 1302b5 between alignment feature 1302b1 and a working surface 1302b2, and yet another plurality of protrusions 1302b2a extending from working surface 1302b2. For the purposes of conciseness, other possible combinations of features are not illustrated. However, it is contemplated that any combination of features (protrusions or depressions, curved alignment feature surface or straight alignment feature surface, etc.) is contemplated and within the scope of the invention. The tip portion 1302b illustrated in FIGS. 15A-15C may be described as an embodiment where alignment feature 1302b1 includes a plurality of tapered portions (i.e., fifteen regions of alignment feature 1302b1) extending toward working surface 1302b2.

Various embodiments of the invention have been described with respect to an alignment feature including a tapered surface along with a plurality of protrusions (e.g., tapered protrusions) extending from the tapered surface (e.g., see FIGS. 5A-5C, FIGS. 6A-6C, FIGS. 12A-12C, FIGS. 13A-13C, FIGS. 15A-15C. etc.), or a plurality of depressions extending below the tapered surface (e.g., see FIGS. 7A-7C, etc.). For example, see alignment feature 302b1 in FIGS. 5A-5C, including a plurality of protrusions 302b1a (e.g., tapered protrusions) extending from a tapered surface (not labelled) of alignment feature 302b1. However, the invention is not limited to such embodiments. For example, a plurality of protrusions included in the alignment feature may extend from a planar (or flat surface) as opposed to a tapered surface-where such a planar surface may be continuous with the working surface.

Further, various embodiments of the invention have been illustrated with respect to a sonotrode having an outer portion (e.g., beyond the alignment feature) of the tip portion that is planar. For example, see outer portion 102b3 in FIGS. 3A-3C, outer portion 202b3 in FIGS. 4A-4C, outer portion 302b3 in FIGS. 5A-5C, outer portion 402b3 in FIGS. 6A-6C, outer portion 502b3 in FIGS. 7A-7C, outer portion 602b3 in FIGS. 8A-8C, outer portion 702b3 in FIGS. 9A-9C, outer portion 802b3 in FIGS. 10A-10C, outer portion 902b3 in FIGS. 11A-11C, outer portion 1002b3 in FIGS. 12A-12C, outer portion 1102b3 in FIGS. 13A-13C, outer portion 1202b3 in FIGS. 14A-14C, and outer portion 1302b3 in FIGS. 15A-15C. However, the invention is not limited to such a planar outer surface. For example, the outer portion in any of the embodiments shown or described herein (or otherwise within the scope of the invention) may be non-planar. Such a non-planar outer portion may include a plurality of protrusions arranged in a radial (e.g., circular) configuration. Such protrusions may be continuous with respective protrusions included in the alignment feature. The “gaps” or “depressions” between such protrusions may provide a path for excess material or “whiskers” formed from the ultrasonic welding process to exit the tip of the sonotrode (where such whiskers are material from bonded conductive pins). By providing a path for the excess material or whisker material to exit the sonotrode, the potential for undesirable material build up at the sonotrode tip is reduced.

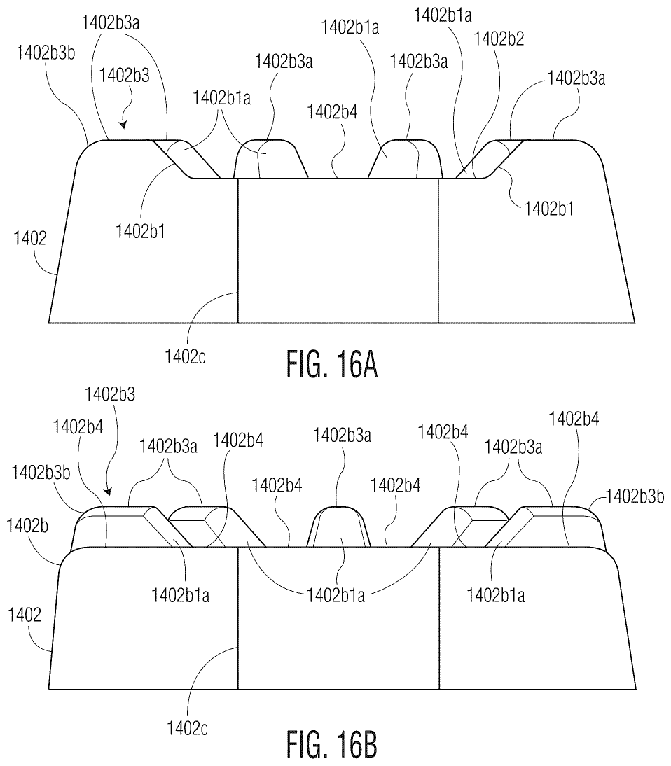

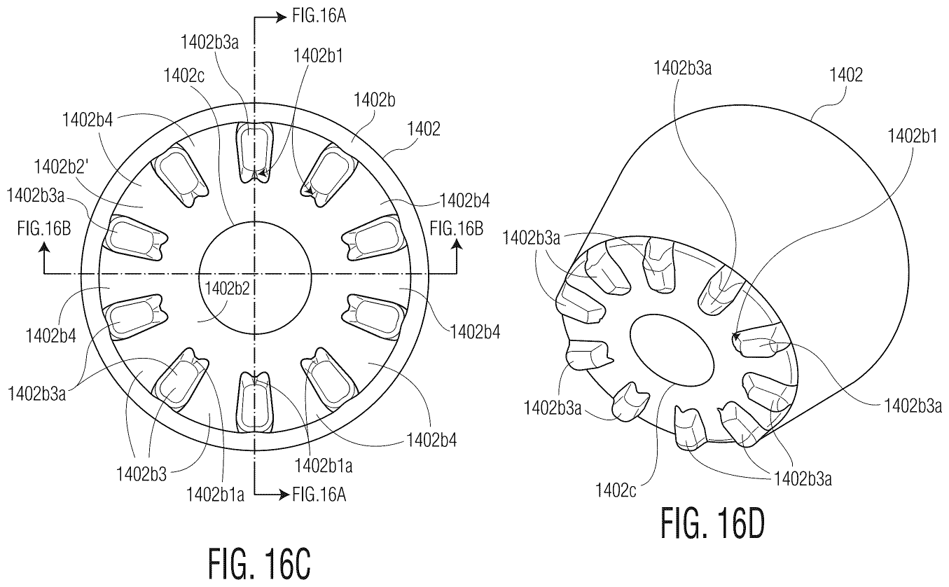

As detailed below, each of FIGS. 16A-16D, FIGS. 17A-17D, FIGS. 18A-18D, and FIGS. 19A-19D illustrate examples of the features described in the immediately preceding two paragraphs.

FIGS. 16A-16D illustrate a tip portion 1402b of a sonotrode 1402. Tip portion 1402b includes an aperture 1402c, a working surface 1402b2 (e.g., a flat and/or planar working surface), an alignment feature 1402b1, and an outer portion 1402b3. Outer portion 1402b3 is provided between alignment feature 1402b1 and an outer edge 1402b3b of tip portion 1402b (e.g., the intersection of an outer wall of tip portion 1402b and bottom surface of tip portion 1402b). Alignment feature 1402b1 includes a plurality of tapered portions 1402b1a arranged in a radial configuration/pattern around aperture 1402c, with the tapered portions 1402b1a extending above a planar surface 1402b2′ (e.g., where planar surface 1402b2′ is continuous with working surface 1402b2 of tip portion 1402b). Outer portion 1402b3 includes a plurality of outer protrusions 1402b3a extending above planar surface 1402b2′. Depressions 1402b4 are defined between ones of the plurality of outer protrusions 1402b3a and between ones of the tapered portions 1402b1a. As shown in FIGS. 16A-16D, each of the plurality of tapered portions 1402b1a is integrated with a corresponding one of the plurality of outer protrusions 1402b3a (e.g., a tapered portion 1402b1a and an outer protrusion 1402b3a are formed as a single structure, formed from a unitary piece of material, etc.). Depressions 1402b4 between outer protrusions 1402b3a may be configured to allow for outflow of material (e.g., whiskers) produced in connection with an ultrasonic welding process.

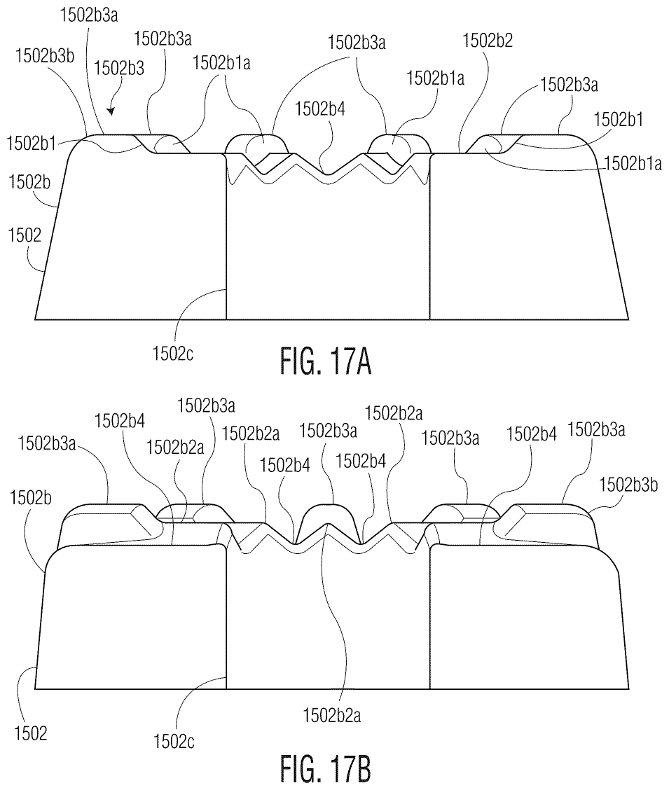

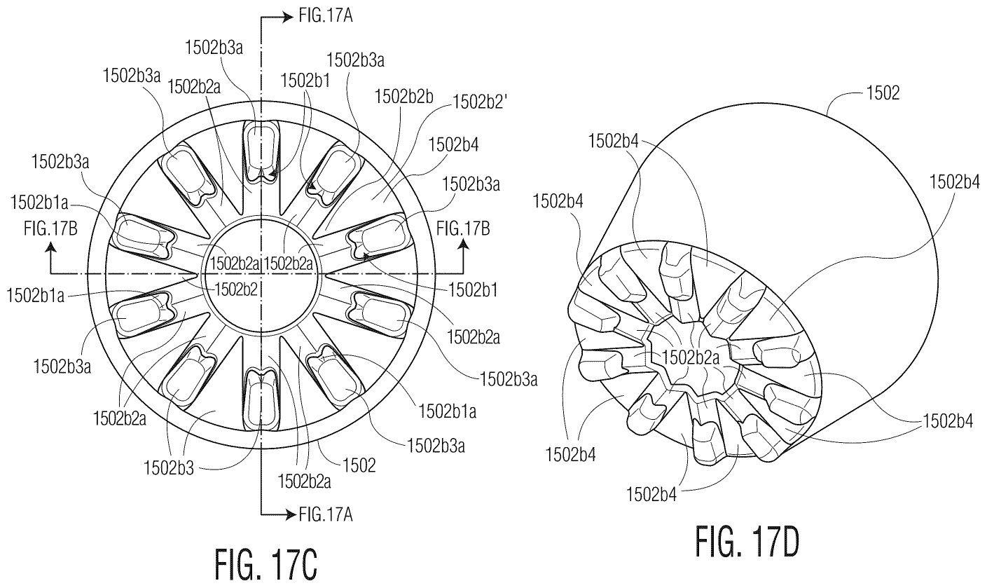

FIGS. 17A-17D illustrate a tip portion 1502b of a sonotrode 1502. Tip portion 1502b includes an aperture 1502c, a working surface 1502b2, an alignment feature 1502b1, and an outer portion 1502b3. Working surface 1502b2 includes a plurality of working surface protrusions 1502b2a (e.g., triangular or pyramidal protrusions are illustrated) as well as a plurality of depressions 1502b2b (e.g., planar portions) therebetween (only one of the plurality of depressions 1502b2b is labelled in FIG. 17C). Outer portion 1502b3 is provided between alignment feature 1502b1 and an outer edge 1502b3b of tip portion 1502b (e.g., the intersection of an outer wall of tip portion 1502b and bottom surface of tip portion 1502b). Alignment feature 1502b1 includes the plurality of tapered portions 1502b1a arranged in a radial configuration/pattern around aperture 1502c, with the tapered portions 1502b1a extending above a planar surface 1502b2′ (e.g., where planar surface 1502b2′ is continuous with a portion of working surface 1502b2 of tip portion 1502b, namely with the plurality of depressions 1502b2b of working surface 1502b2). Outer portion 1502b3 includes a plurality of outer protrusions 1502b3a extending above planar surface 1502b2′. Depressions 1502b4 are defined between ones of the plurality of outer protrusions 1502b3a and between ones of the tapered portions 1502b1a. As shown in FIGS. 17A-17D, each of the plurality of tapered portions 1502b1a is integrated with a corresponding one of the plurality of outer protrusions 1502b3a (e.g., a tapered portion 1502b1a and an outer protrusion 1502b3a are formed as a single structure, formed from a unitary piece of material, etc.). Likewise, in the embodiment illustrated in FIGS. 17A-17D, each of the plurality of working surface protrusions 1502b2a are integrated with a corresponding one of the plurality of tapered portions 1502b1a and a corresponding one of outer protrusions 1502b3a. Depressions 1502b4 between outer protrusions 1502b3a may be configured to allow for outflow of material (e.g., whiskers) produced in connection with an ultrasonic welding process.

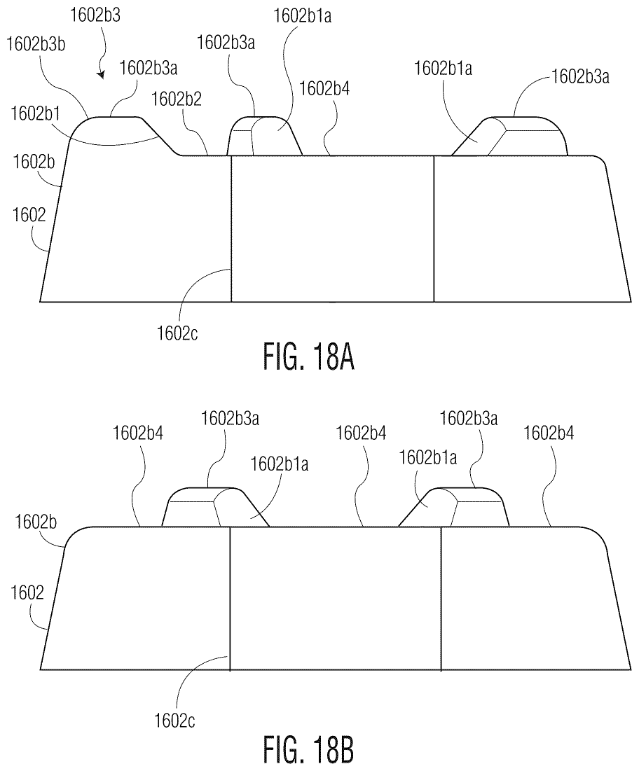

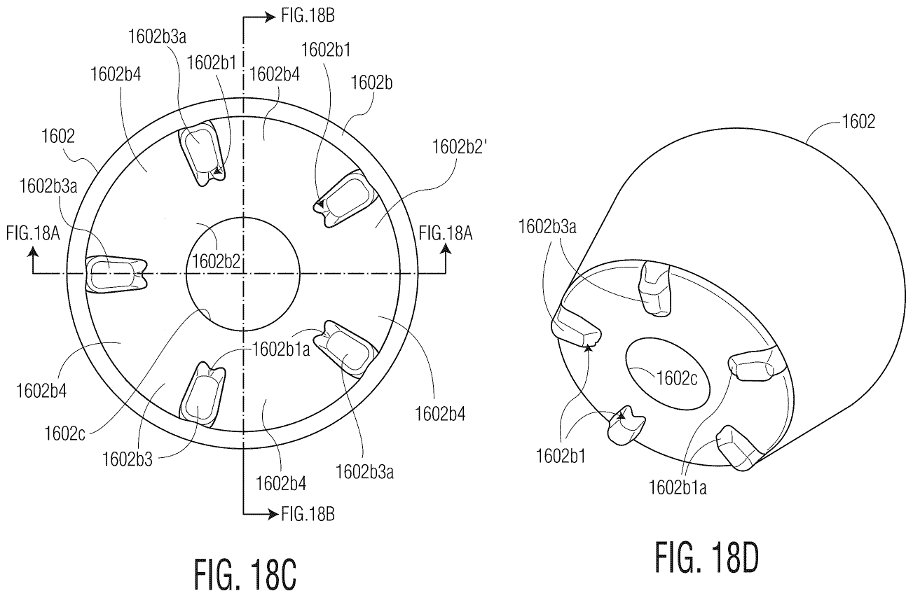

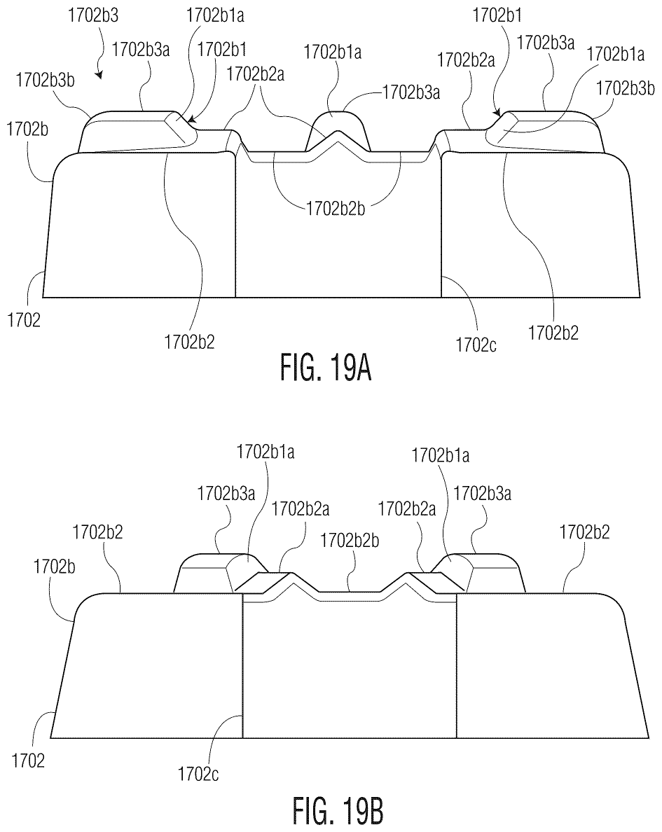

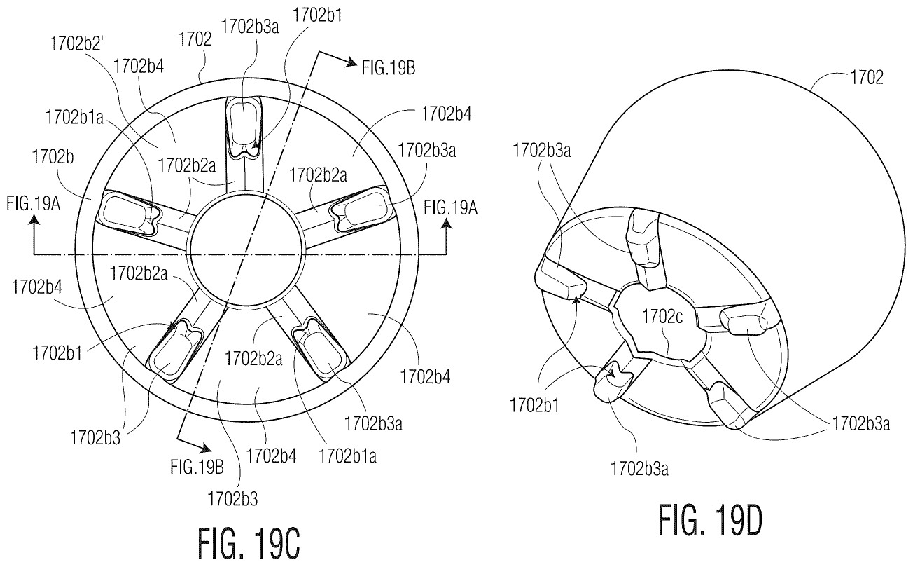

While FIGS. 16A-16D and FIGS. 17A-17D illustrate ten protrusions, the invention is not so limited. The number of protrusions may be any number depending on the application. For example, FIGS. 18A-18D and FIGS. 19A-19D include five protrusions.

FIGS. 18A-18D illustrate a tip portion 1602b of a sonotrode 1602. Tip portion 1602b includes an aperture 1602c, a working surface 1602b2 (e.g., a flat and/or planar working surface), an alignment feature 1602b1, and an outer portion 1602b3. Outer portion 1602b3 is provided between alignment feature 1602b1 and an outer edge 1602b3b of tip portion 1602b (e.g., the intersection of an outer wall of tip portion 1602b and bottom surface of tip portion 1602b). Alignment feature 1602b1 includes a plurality of tapered portions 1602b1a arranged in a radial configuration/pattern around aperture 1602c, with the tapered portions 1602b1a extending above a planar surface 1602b2′ (e.g., where planar surface 1602b2′ is continuous with working surface 1602b2 of tip portion 1602b). Outer portion 1602b3 includes a plurality of outer protrusions 1602b3a extending above planar surface 1602b2′. Depressions 1602b4 are defined between ones of the plurality of outer protrusions 1602b3a and between ones of the tapered portions 1602b1a. As shown in FIGS. 18A-18D, each of the plurality of tapered portions 1602b1a is integrated with a corresponding one of the plurality of outer protrusions 1602b3a (e.g., a tapered portion 1602b1a and an outer protrusion 1602b3a are formed as a single structure, formed from a unitary piece of material, etc.). Depressions 1602b4 between outer protrusions 1602b3a may be configured to allow for outflow of material (e.g., whiskers) produced in connection with an ultrasonic welding process.

FIGS. 19A-19D illustrate a tip portion 1702b of a sonotrode 1702. Tip portion 1702b includes an aperture 1702c, a working surface 1702b2, an alignment feature 1702b1, and an outer portion 1702b3. Working surface 1702b2 includes a plurality of working surface protrusions 1702b2a (e.g., triangular or pyramidal protrusions are illustrated) as well as a plurality of depressions 1702b2b (e.g., planar portions). Outer portion 1702b3 is provided between alignment feature 1702b1 and an outer edge 1702b3b of tip portion 1702b (e.g., the intersection of an outer wall of tip portion 1702b and bottom surface of tip portion 1702b). Alignment feature 1702b1 includes the plurality of tapered portions 1702b1a arranged in a radial configuration/pattern around aperture 1702c, with the tapered portions 1702b1a extending above a planar surface 1702b2′ (e.g., where planar surface 1702b2′ is continuous with a portion of working surface 1702b2 of tip portion 1702b, namely with the plurality of depressions 1702b2b of working surface 1702b2). Outer portion 1702b3 includes a plurality of outer protrusions 1702b3a extending above planar surface 1702b2′. Depressions 1702b4 are defined between ones of the plurality of outer protrusions 1702b3a and between ones of the tapered portions 1702b1a. As shown in FIGS. 19A-19D, each of the plurality of tapered portions 1702b1a is integrated with a corresponding one of the plurality of outer protrusions 1702b3a (e.g., a tapered portion 1702b1a and an outer protrusion 1702b3a are formed as a single structure, formed from a unitary piece of material, etc.). Likewise, in the embodiment illustrated in FIGS. 19A-19D, each of the plurality of working surface protrusions 1702b2a are integrated with a corresponding one of the plurality of tapered portions 1702b1a and a corresponding one of outer protrusions 1702b3a. Depressions 1702b4 between outer protrusions 1702b3a may be configured to allow for outflow of material (e.g., whiskers) produced in connection with an ultrasonic welding process.

It should be understood that various features of the embodiments illustrated in FIGS. 16A-16D, 17A-17D, 18A-18D, and 19A-19D may be combined with any one or more embodiments within the scope of the invention, including but not limited to those illustrated in FIG. 1, FIGS. 2A-2F, FIGS. 3A-3C, FIGS. 4A-4C, FIGS. 5A-5C, FIGS. 6A-6C, FIGS. 7A-7C, FIGS. 8A-8C, FIGS. 9A-9C, FIGS. 10A-10C, FIGS. 11A-11C, FIGS. 12A-12C, FIGS. 13A-13C, FIGS. 14A-14C, and/or FIGS. 15A-15C, and vice versa.

Various sonotrodes within the scope of the invention (including many of those described herein) include a body portion terminating at a tip portion. The body portion and the tip portion may be formed from a unitary piece of material (e.g., steel, stainless steel, a metal alloy, etc.). Alternatively, the body portion and the tip portion may be separate pieces coupled together (e.g., through brazing or other techniques). In connection with embodiments where the body portion and the tip portion are separate pieces, examples of the material of the body portion include steel, stainless steel, a metal alloy, etc., and examples of materials of the tip portion include ceramic, steel, and carbide materials, or a metal alloy.

Aspects of the invention relate to the inclusion of various features at the tip portion of a sonotrode (e.g., protrusions, depressions, grooves, etc.). These features may be formed in the tip portion using any of a number of techniques such as laser scribing, laser irradiation, electro-discharge machining, etc.

Although the invention is illustrated and described herein with reference to an aligned condition of the conductive pin being centered within the sonotrode, the invention is not intended to be limited to such an embodiment. It is contemplated that the geometry of the alignment feature could be manipulated to achieve any desirable alignment condition, including a particular depth of the conductive pin within the sonotrode, an angle of the conductive pin within the sonotrode, or a position of the conductive pin within the sonotrode. It is also contemplated that a single sonotrode could be configured to align a variety of conductive pin geometries as desired (e.g., utilizing a stepped geometry rather than a single surface).

Although the invention is illustrated and described herein with reference to specific embodiments, the invention is not intended to be limited to the details shown. Rather, various modifications may be made in the details within the scope and range of equivalents of the claims and without departing from the invention.

1. A sonotrode configured for use in an ultrasonic welding system comprising:
a body portion terminating at a tip portion, the tip portion including (i) an alignment feature and (ii) a working surface configured to press against a base portion of a conductive pin during an ultrasonic welding process,
the working surface defining an aperture configured to receive an elongate portion of the conductive pin, the alignment feature being configured to align the conductive pin with respect to the aperture.

2. The sonotrode of claim 1 wherein the alignment feature is a tapered surface of the tip portion extending toward the working surface.

3. The sonotrode of claim 1 wherein the alignment feature includes a plurality of tapered portions extending toward the working surface.

4. The sonotrode of claim 3 wherein depressions are defined between the plurality of tapered portions.

5. The sonotrode of claim 3 wherein the plurality of tapered portions extend above a planar surface of the tip portion.

6. The sonotrode of claim 5 wherein the planar surface is continuous with the working surface.

7. The sonotrode of claim 3 wherein the tip portion defines an outer portion between the alignment feature and an outer edge of the tip portion, the outer portion including (i) a plurality of outer protrusions and (ii) depressions between ones of the plurality of outer protrusions.

8. The sonotrode of claim 7 wherein ones of the plurality of tapered portions are integrated with ones of the plurality of outer protrusions.

9. The sonotrode of claim 7 wherein the plurality of tapered portions and the plurality of outer protrusions extend above a planar surface of the tip portion.

10. The sonotrode of claim 9 wherein the planar surface is continuous with the working surface.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. An ultrasonic welding system including:
a support structure configured for supporting a workpiece; and
a weld head assembly including an ultrasonic converter carrying a sonotrode configured for use in the ultrasonic welding system, the sonotrode including a body portion terminating at a tip portion, the tip portion including (i) an alignment feature and (ii) a working surface configured to press against a base portion of a conductive pin during an ultrasonic welding process, the working surface defining an aperture configured to receive an elongate portion of the conductive pin, the alignment feature being configured to align the conductive pin with respect to the aperture.

27. The ultrasonic welding system of claim 26 wherein the alignment feature is a tapered surface of the tip portion extending toward the working surface.

28. The ultrasonic welding system of claim 26 wherein the alignment feature includes a plurality of tapered portions extending toward the working surface.

29. The ultrasonic welding system of claim 28 wherein depressions are defined between the plurality of tapered portions.

30. The ultrasonic welding system of claim 28 wherein the plurality of tapered portions extend above a planar surface of the tip portion.

31. The ultrasonic welding system of claim 30 wherein the planar surface is continuous with the working surface.

32. The ultrasonic welding system of claim 28 wherein the tip portion defines an outer portion between the alignment feature and an edge of the tip portion, the outer portion including (i) a plurality of outer protrusions and (ii) depressions between ones of the plurality of outer portions.

33. The ultrasonic welding system of claim 32 wherein ones of the plurality of tapered portions are integrated with ones of the plurality of outer protrusions.

34. The ultrasonic welding system of claim 32 wherein the plurality of tapered portions and the plurality of outer protrusions extend above a planar surface of the tip portion.

35. The ultrasonic welding system of claim 34 wherein the planar surface is continuous with the working surface.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method of operating an ultrasonic welding system comprising the steps of:
(a) providing a conductive pin to a sonotrode of the ultrasonic welding system, the sonotrode including a body portion terminating at a tip portion, the tip portion including (i) an alignment feature and (ii) a working surface configured to press against a base portion of the conductive pin during an ultrasonic welding process; and
(b) aligning the conductive pin with respect to an aperture defined by the sonotrode using the alignment feature.

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)
